(19) United States
(12) Patent Application Publication
(10) Pub. No.: US 2020/0376308 A1
(43) Pub. Date: Dec. 3, 2020

(54) INTEGRATED RING ATTACHMENT POSITIONER WITH SELF-RETRACTING DEVICE CONNECTION

(71) Applicant: Alexander Andrew, Inc. DBA Falltech, Compton, CA (US)

(72) Inventors: Michael Dancyger, Los Angeles, CA (US); Samuel Raymond Andrade, Norwalk, CA (US)

(21) Appl. No.: 16/994,612

(22) Filed: Aug. 16, 2020

Related U.S. Application Data
(63) Continuation-in-part of application No. 15/635,331, filed on Jun. 28, 2017.

(51) Int. Cl. A62B 35/00; A44B 11/02; F16G 11/00

(52) U.S. Cl. CPC A62B 35/0037; F16G 11/00; A44B 11/02

(57) ABSTRACT

A device includes a base plate having multiple entry webbing slots, multiple exit webbing slots and multiple webbing transition slots. A ring connection element is integrated in the base plate. The ring connection element includes an opening configured for removably attachment with a ring device. A self-retracting device (SRD) connection is integrated with the ring connection element.

### CROSS-REFERENCE TO RELATED APPLICATIONS

This application is a continuation-in-part of U.S. Ser. No. 15/635,331, filed on Jun. 28, 2017, which claims the priority benefit of U.S. Provisional Patent Application Ser. No. 62/409,779, filed Oct. 18, 2016, incorporated herein by reference in its entirety.

### BACKGROUND

The personal protective equipment (PPE) market has experienced a significant shift on the safety connection between the human body equipped with a safety harness and a secure anchor point. The traditional fixed length lanyards are being replaced by the use of self-retracting devices (SRDs). This market shift to SRDs has created several issues for the end users.

The relatively light weight fixed length lanyard is now being replaced by retractables, weighing significantly more, and is creating an industry wide safety issue for the end user in regards to the dorsal D-ring location. Due to the increased weight, the dorsal D-ring (the “D” shaped connector for SRDs) and any pad connected to it tends to slide down the user's back due to the weight of retractibles (often used in a set of two). This is creating a potentially catastrophic situation in both feet first and head first fall events due to movement of the SRD(s) connector point.

Typical installation of SRDs to the dorsal D-ring area is a time consuming process. Conventionally, the user needs to create a loop out of the torso webbing just below the dorsal D-ring then pass the SRD attachment point (often a safety rated carabiner) through this loop of webbing. This can be challenging for end users and can consume up to fifteen (15) minutes for installation and another fifteen (15) minutes for removal of the SRDs.

### SUMMARY

Embodiments relate to integration of a pre-established SRD connection point into a dorsal ring (e.g., D-ring, oval ring, etc.) “keeper.” One embodiment includes an apparatus that includes a ring connection element having an opening configured to removably connect with a ring device (e.g., a D-ring, oval ring, etc.) and an SRD attachment port integrated with the ring connection element. One embodiment connects to or is integrated with a base plate that includes one or more integrated tension clips to secure the SRD connection point and to prevent the entire assembly from re-positioning.

Another embodiment provides a device that includes a base plate having multiple entry webbing slots, multiple exit webbing slots and multiple webbing transition slots. A ring connection element is integrated in the base plate. The ring connection element includes an opening configured for removably attachment with a ring device. A self-retracting device (SRD) connection is integrated with the ring connection element.

These and other features, aspects and advantages of the present invention will become understood with reference to the following description, appended claims and accompanying figures.

### BRIEF DESCRIPTION OF THE DRAWINGS

FIG. 1 shows a side view of an integrated SRD connection point and (dorsal) D-ring position keeper, according to an embodiment;

FIG. 2 shows a top view of the integrated SRD connection point and (dorsal) D-ring position keeper of FIG. 1, according to an embodiment;

FIG. 3 shows a side view of another integrated SRD connection point and (dorsal) D-ring position keeper, according to an embodiment;

FIG. 4 shows a top view of the integrated SRD connection point and (dorsal) D-ring position keeper of FIG. 3, according to an embodiment;

FIG. 5 shows a side view of yet another integrated SRD connection point and (dorsal) D-ring position keeper, according to an embodiment;

FIG. 6 shows a top view of the integrated SRD connection point and (dorsal) D-ring position keeper of FIG. 5, according to an embodiment;

FIG. 7 shows a perspective view of still another integrated SRD connection point and (dorsal) D-ring position keeper, according to an embodiment;

FIG. 8 shows a perspective view of an integrated SRD connection point and (dorsal) D-ring position keeper, according to an embodiment;

FIG. 9 shows a top view of the integrated SRD connection point and (dorsal) D-ring position keeper of FIG. 8 shown with an exemplary D-ring and harness, according to an embodiment;

FIG. 10 shows a perspective view of the integrated SRD connection point and (dorsal) D-ring position keeper of FIG. 9 shown with the exemplary D-ring and harness, according to an embodiment;

FIG. 11 shows an integrated webbing tension clip, according to an embodiment;

FIG. 12 shows another integrated webbing tension clip, according to an embodiment;

FIG. 13A shows a front view of another device including an integrated SRD connection point and D-ring position keeper, according to one embodiment;

FIG. 13B shows a rear view of the device of FIG. 13A including the integrated SRD connection point and D-ring position keeper, according to one embodiment;

FIG. 14A shows a top view of the device of FIG. 13A including the integrated SRD connection point and D-ring position keeper, according to one embodiment;

FIG. 14B shows a bottom view of the device of FIG. 13A including the integrated SRD connection point and D-ring position keeper, according to one embodiment;

FIG. 15A shows a right side view of the device of FIG. 13A including the integrated SRD connection point and D-ring position keeper, according to one embodiment;

FIG. 15B shows a left side view of the device of FIG. 13A including the integrated SRD connection point and D-ring position keeper, according to one embodiment;

FIG. 16 shows a front view of the device of FIG. 13A including the integrated SRD connection point and D-ring position keeper that is shown with example webbing from a fall protection harness, according to one embodiment; and

FIG. 17 shows a front view of the device of FIG. 13A including the integrated SRD connection point and D-ring position keeper that is shown with an example fall protection harness, according to one embodiment.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to integration of a pre-established SRD connection point into a dorsal ring (e.g., D-ring, oval ring, etc.) “keeper.” One embodiment includes an apparatus that includes a ring connection element having an opening configured to removably connect with a ring device (e.g., a D-ring, oval ring, etc.) and an SRD attachment port integrated with the ring connection element. One embodiment connects to or is integrated with a base plate that includes one or more integrated tension clips to secure the SRD connection point and to prevent the entire assembly from re-positioning.

Some conventional connection points are not fixed to a D-ring plate, which makes it hard for a user to attach this component and difficult for the component to remain in the correct location. Many conventional devices also fail to address the added weight of SRDs and the inherent slippage caused by this added weight. Other conventional SRD attachment points consist of a metal part built into or off of the dorsal D-ring. This is a heavy and costly alternative and does not address the slippage caused by the weight of SRDs added to a safety harness.

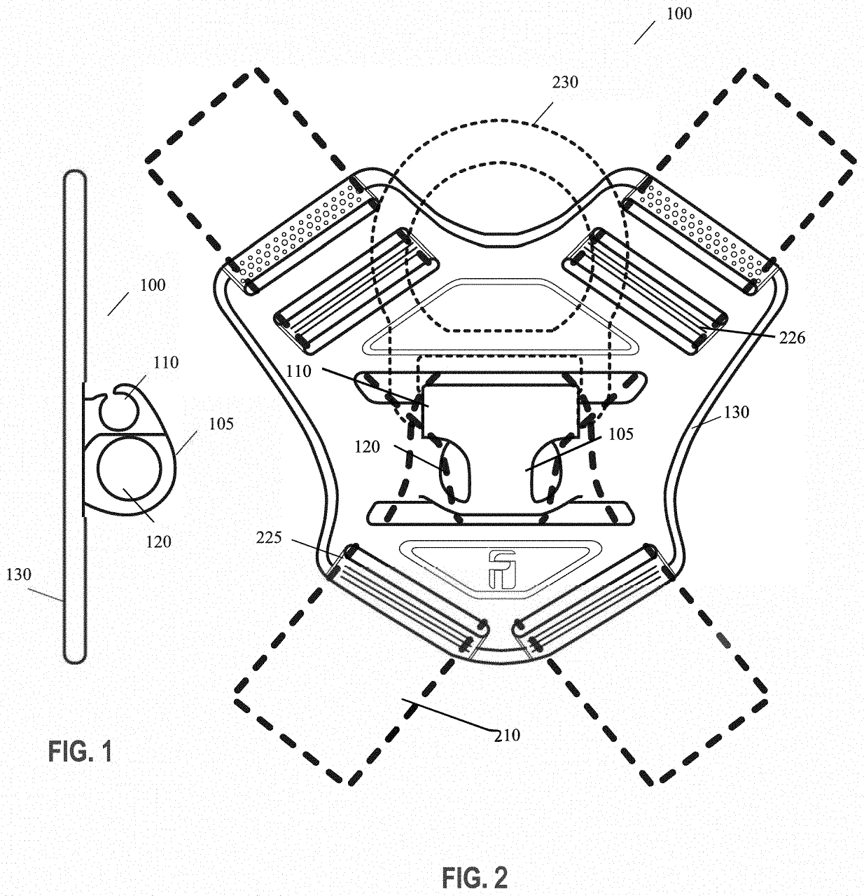

FIG. 1 shows a side view of a device 100 including an integrated SRD connection point 120 and (dorsal) D-ring position keeper (or connection point) 110, according to an embodiment. The device 100 includes a base plate 130, SRD connection point (or SRD quick attachment port) 120 with outer portion 105 and D-ring position keeper 110. In one embodiment, the D-ring position keeper 110 includes an opening for placement of a D-ring device (e.g., D-ring 230, FIG. 2), or other ring type devices (e.g., an oval ring, circular ring, etc.). The D-ring position keeper 110 provides stability of a D-ring that is placed in the D-ring position keeper 110 along with webbing (e.g., webbing 210, FIG. 2) that is placed over an opening portion of a D-ring (or other ring device). In one embodiment, the SRD connection point 120 includes a though-hole or slot for placement of an SRD connector (e.g., round carabiners, oval carabiners, etc. either made of aluminum, steel, etc.).

FIG. 2 shows a top view of the device 100 including the integrated SRD connection point 120 and (dorsal) D-ring position keeper 110 of FIG. 1, according to an embodiment. In one embodiment, the device 100 further includes webbing slots 225 and integrated tension clips 226 for webbing 210 (e.g., webbing from a safety harness). The webbing slots 225 provide a functional means to incorporate the torso webbing from a safety harness through the base plate 130 or the D-ring keeper 110 with an SRD adaptor assembly. Without this feature the critical dorsal D-ring placement would be lost and the safety of the user would be jeopardized.

In one embodiment, the base plate 130 is the foundation of the device 100 providing the surface in which to build all the other components on. The base plate 130 may be made in a variety of shapes and sizes, ranging from a simple flat shape to a complex multifaceted, multi-contoured shape. The base plate 130 may be sewn in place on padding, riveted, epoxy welded, etc. In one embodiment, the materials for the base plate 130 may range from steel, a steel alloy, an aluminum alloy, plastic resins, leather, fabric, etc.

In one embodiment, the D-ring keeper 110 is a feature that allows a (dorsal) D-ring 230 to maintain a safe and fixed distance from the SRD connection point 120. If the D-ring keeper 110 and the SRD connection point 120 are not within reasonable proximity of each other, the device 100 function can be jeopardized by becoming lost once the safety harness webbing 210 has been laced through the base plate 130 via the webbing slots 225 and integrated tension clips 226. The D-ring keeper 110 may also be strategically contoured or shaped to suit the intended D-ring 230 creating a stand-up or upright D-ring position, which makes it easier for the user to connect/disconnected lanyards and SRDs that are allowed to be connected directly to a dorsal D-ring. In one embodiment, the D-ring 230 is held in place by in a specific location. SRDs have a specific allowable usage marked on every unit. For example, the device can be used only for . . . overhead, 2′ below D-ring, 3′ below D-ring, 4′ below D-ring or foot level tie-off, etc. These are very specific instructions on personal SRDs. Therefore, if the SRD connection point 120 is too far away from the D-ring 230 one can end up with a miscalculation on the clear fall distance, which is the amount of distance one needs to calculate for a fall to prevent the user from hitting the lower level (or ground).

In one embodiment, the SRD connection point 120 creates a fixed loop on the base plate 130 allowing the torso webbing (e.g., webbing 210) from a safety harness to go over the top portion 105 and around the SRD connection point 120 to create a fast and safe connection for SRD attachment devices. The SRD connection point 120 may either be formed directly into the base plate 130 or permanently affixed to the base plate 130 through other means, such as riveting, cementing, a formed connection point method, etc. In one embodiment, materials used for the SRD connection point 120 may range from metal, metal alloy (e.g., steel alloy, aluminum alloy, etc.), plastic resins, leather, fabric, etc. The SRD connection point 120 may be made in the same material as the base plate 130, or alternative materials or an alternative material property (i.e., harder or softer).

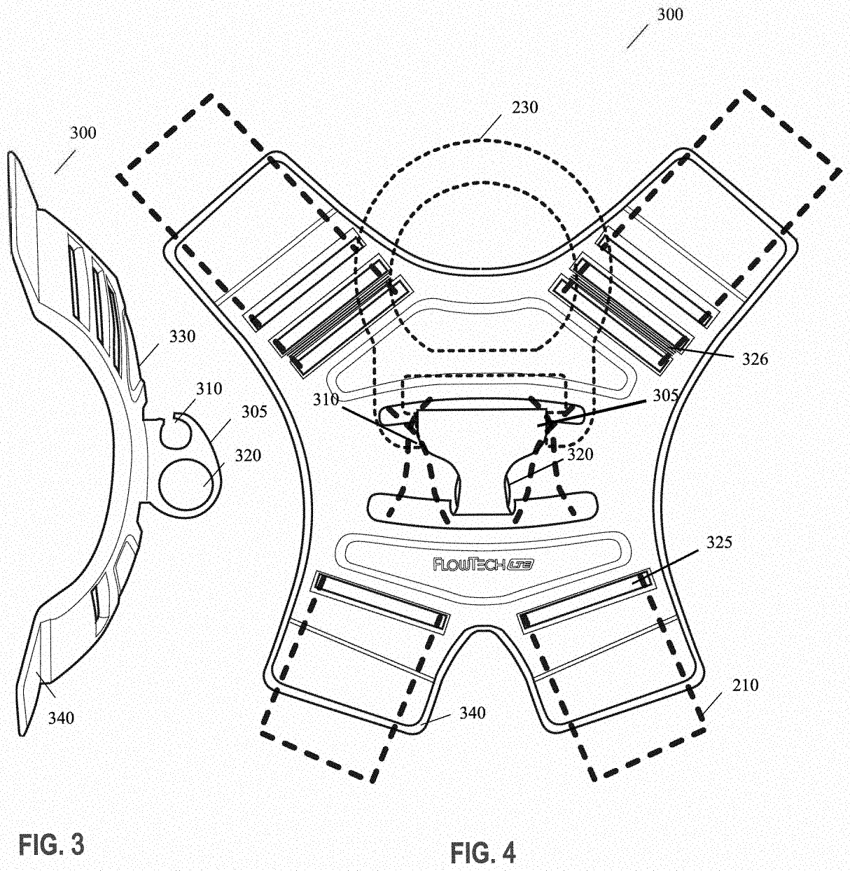

FIG. 3 shows a side view of a device 300 including another integrated SRD connection point 320 and (dorsal) D-ring position keeper 310, according to an embodiment. In one embodiment, the device 300 includes a curved or raised base plate 330, SRD connection point (or SRD quick attachment port) 320 with outer portion 305 and D-ring position keeper 310. Device 300 is similar to device 100 (FIGS. 1 and 2) albeit the shape, contour and position of components.

FIG. 4 shows a top view of the device 300 including integrated SRD connection point 320 and (dorsal) D-ring position keeper 310 of FIG. 3, according to an embodiment. In one embodiment, the device 300 includes four leg extensions 340 that may be placed in pockets of padding or a safety harness upper portion for stability of the base plate 330 and other components. The base plate 330 includes webbing slots 325 and integrated tension clips 326.

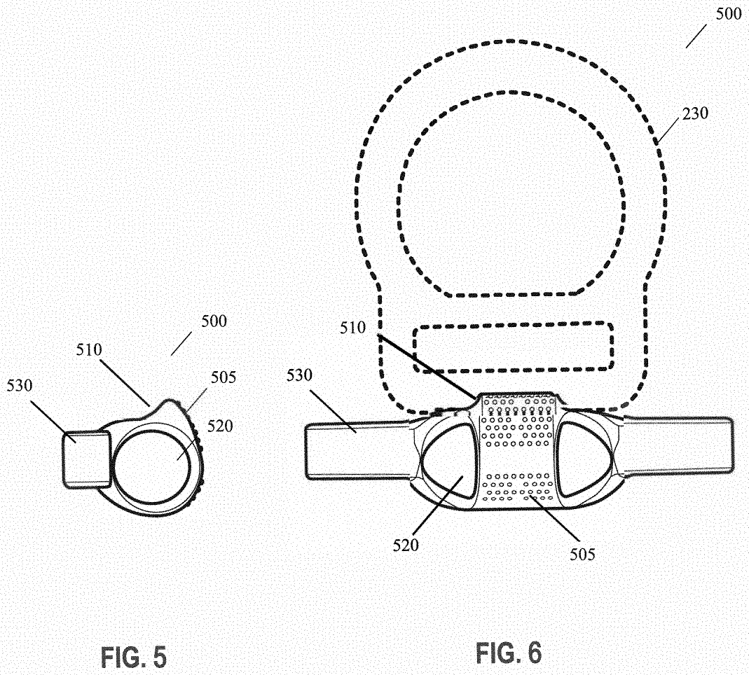

FIG. 5 shows a side view of a device 500 including yet another integrated SRD connection point 520 and (dorsal) D-ring position keeper 510, according to an embodiment. In one embodiment, the device 500 includes a curved or raised D-ring position keeper 510, SRD connection point (or SRD quick attachment port) 520 with outer portion 505 and attachment bar 530. The device 500 may be made of similar materials as the devices 100 and 300 discussed above.

FIG. 6 shows a top view of the device 500 including the integrated SRD connection point 520 and (dorsal) D-ring position keeper 510 of FIG. 5, according to an embodiment. In one embodiment, the device 500 is held in place by having the attachment bar 530 attached to padding or an upper portion of a webbing harness via sewing, welding, riveting, pockets formed around the attachment bar 530 ends, etc. In one embodiment, webbing is placed over the device 500 (e.g., over the outer portion 505, attachment bar 530) and through a lower opening of the D-ring 230. The curved portion of the D-ring keeper 510 maintains the D-ring 230 at a fixed distance from (positioned above) an SRD connector fastened through the SRD connection point 520.

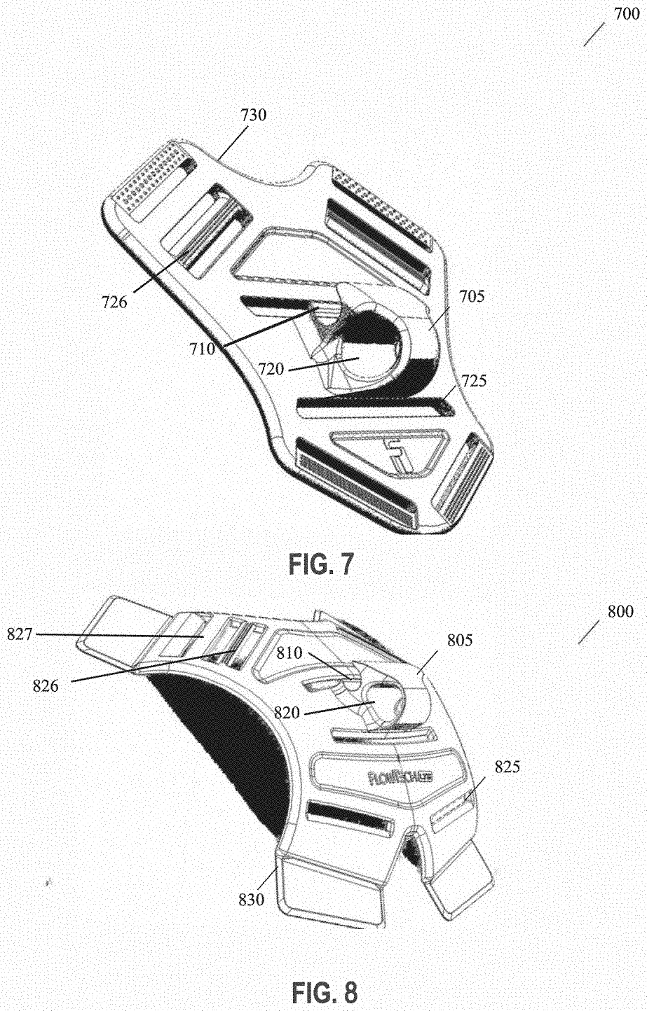

FIG. 7 shows a perspective view of a device 700 including still another integrated SRD connection point 720 and (dorsal) D-ring position keeper 710, according to an embodiment. In one embodiment, the device 700 includes a flat or almost flat base plate 730, outer portion 705 of the SRD connection point 720 and webbing slots 725 and integrated tension clips 726. The device 700 may be made of similar materials as device 100 and 300 as discussed above. In one embodiment, the integrated SRD connection point 720 and the D-ring position keeper 710 may be formed separately from the base plate 730 and attached to the base plate 730 via attachment means, such as welding, fasteners, etc. In another embodiment, the integrated SRD connection point 720 and the D-ring position keeper 710 may be formed together with the base plate 730 (e.g., molded together). The device 700 may be connected to the webbing (e.g., webbing 210, FIGS. 2 and 4) through the webbing slots 725.

FIG. 8 shows a perspective view of a device 800 including an integrated SRD connection point 820 and (dorsal) D-ring position keeper 810, according to an embodiment. In one embodiment, the device 800 includes a curved or raised base plate 830, outer portion 805 of the SRD connection point 820 and webbing slots 825 and integrated tension clips 826. The device 800 may be made of similar materials as device 100 and 300 as discussed above. In one embodiment, the integrated SRD connection point 820 and the D-ring position keeper 810 may be formed separately from the base plate 830 and attached to the base plate 830 via attachment means, such as welding, fasteners, etc. In another embodiment, the integrated SRD connection point 820 and the D-ring position keeper 810 may be formed together with the base plate 830 (e.g., molded together). The device 800 may be connected to the webbing (e.g., webbing 210, FIGS. 2 and 4) through the webbing slots 825.

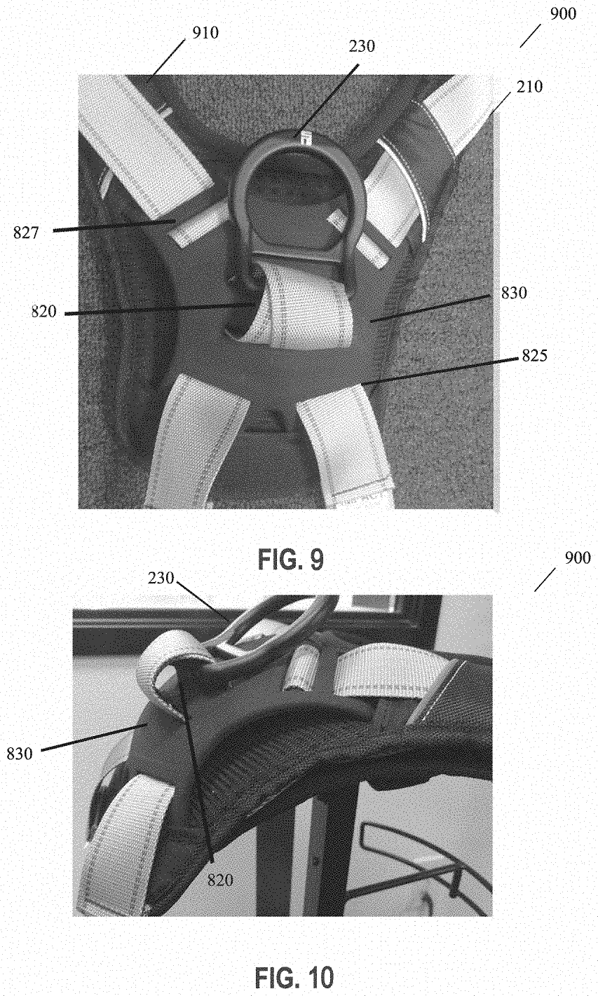

FIG. 9 shows a top view of an example 900 including the integrated SRD connection point 820 and dorsal D-ring position keeper 810 (not shown in FIG. 9 due to webbing 210) of FIG. 8 shown with an exemplary D-ring 230 and harness 910, according to an embodiment. As shown, the webbing 210 is placed through the webbing slots 825 of the base plate 830 and over the outer portion 805 (not shown as the webbing 210 covers the outer portion 805), through the opening in the lower portion of the D-ring 230 and back through further webbing slots 825.

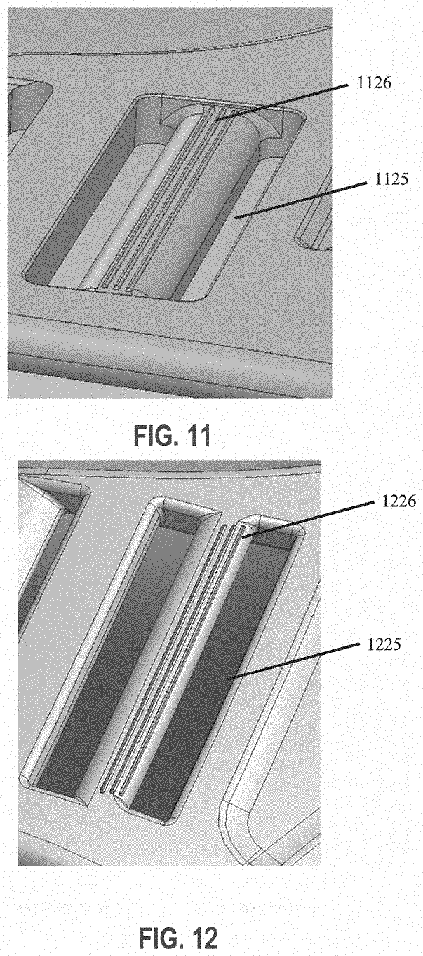

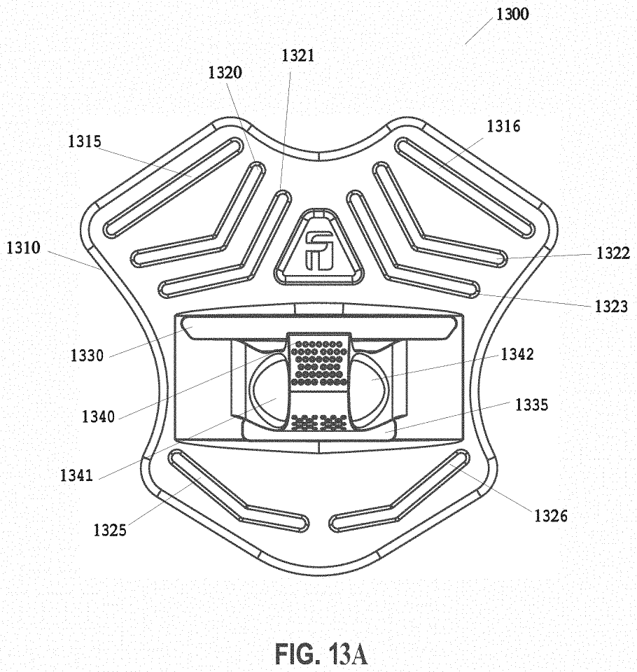

FIG. 10 shows a perspective view of the device 900 of the integrated SRD connection point 820 and dorsal D-ring position keeper 810 of FIG. 9 shown with the exemplary D-ring 230 and harness 910, according to an embodiment.

In one or more embodiments, the outer shape of the devices incorporating a D-ring keeper and SRD connection point (e.g., device 100, FIGS. 1-2, 300, FIGS. 3-4, 500, FIGS. 5-6, 700, FIG. 7, and 800, FIG. 8) along with the inner shape are strategically designed to serve specific purposes. In one example embodiment, the outer shape particularly the narrow top surface and sculpted curved sides along with the inner shape (e.g., oval in a vertical direction being taller than the horizontal direction) are all designed to accommodate common SRD connection options, such as oval carabiners, conventional shaped aluminum carabiners, steel carabiners, etc. that are common to the fall protection market. Without the shape designed in the above-discussed embodiments, the devices would be limited regarding the SRD connection options. In some embodiments, the top outer surface of the device is narrow and the device has sculpted curved sides along with an oval shape in a vertical direction being taller than the horizontal direction. This shape could also be made in the opposite direction with the sides narrow and the oval in a horizontal direction. In some embodiments, whatever direction the oval is taller or longer in, the outer shape has to be narrower in that same direction. In other embodiments, the shape of the through-hole or opening in the SRD connection point may be circular, oval, multi-faceted (e.g., pentagonal, octagonal, etc.), etc.

FIG. 11 shows an integrated webbing tension clip 1126 for webbing slots 1125, according to an embodiment. In one embodiment, the function of the integrated tension clip 1126 is to secure the (dorsal) D-ring keeper (e.g., D-ring keeper 110, FIGS. 1-2, 310, FIGS. 3-4, 510, FIGS. 5-6, 710, FIG. 7, and 810, FIG. 8) in the properly specified location. While webbing slots (e.g., webbing slot 1125) help to hold the (dorsal) D-ring keeper to a safety harness by lacing the webbing through them, these fail to adequately secure the location of the (dorsal) D-ring keeper. In one embodiment, the integrated tension clip 1126 includes multiple raised gripping elements (e.g., 2 or more) on the top portion of the integrated tension clip 1126, which are designed to cause additional friction with webbing and prevent slipping of the webbing when inserted into the webbing slots 1125.

FIG. 12 shows another integrated webbing tension clip 1226 for webbing slots 1225, according to an embodiment. In one embodiment, the function of the integrated tension clip 1126 is to secure the (dorsal) D-ring keeper (e.g., D-ring keeper 110, FIGS. 1-2, 310, FIGS. 3-4, 510, FIGS. 5-6, 710, FIG. 7, and 810, FIG. 8) in the properly specified location. In one embodiment, the integrated tension clip 1226 includes multiple raised gripping elements (e.g., 2 or more) that disposed on an angled portion of the integrated tension clip 1226, which are designed to cause additional friction with webbing and prevent slipping of the webbing when inserted into the webbing slots 1225.

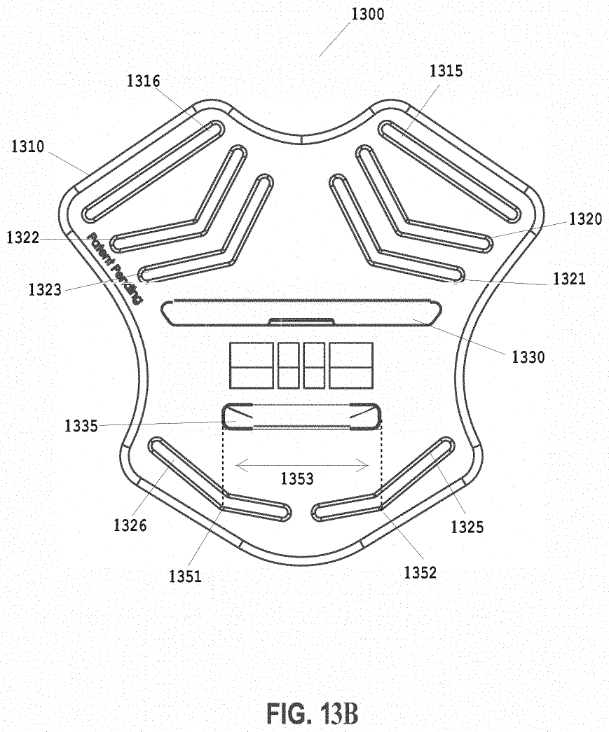

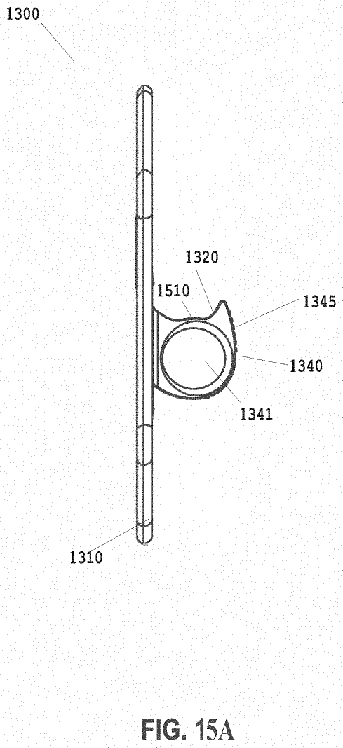

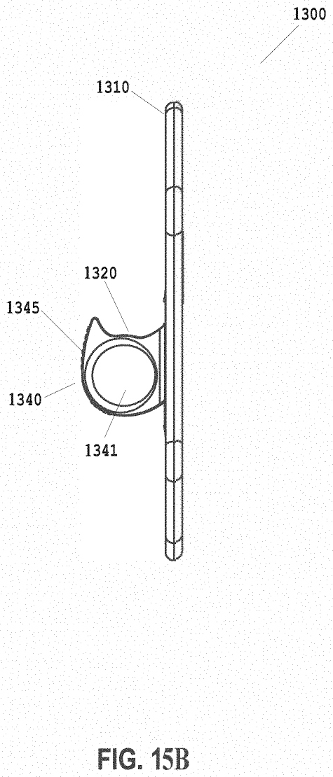

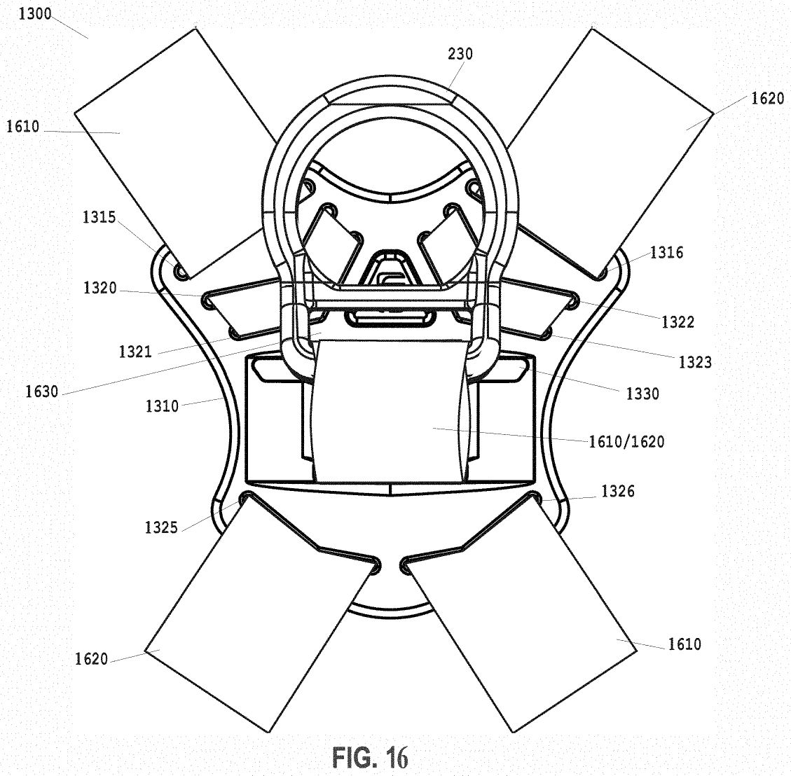

FIG. 13A shows a front view of another device 1300 including an integrated SRD connection point and D-ring position keeper (ring connection element or ring positioner) 1340, according to one embodiment. In some embodiments, the integration of the SRD connection point and D-ring position keeper 1340 is implemented via injection molding, heat welding, etc., which forms a single and solid one-piece device 1300. The SRD connection point (or SRD quick attachment port) includes a fixed loop formed by the through-hole, slot or channel formed from the openings 1341 and 1342, and the D-ring position keeper 1340. The device 1300 further includes a base plate 1310. In one embodiment, the D-ring position keeper 1340 includes openings 1340 and 1341 for placement of a D-ring device (e.g., D-ring 230, FIGS. 2 and 16), or other ring type devices (e.g., an oval ring, circular ring, etc.). The D-ring position keeper 1340 provides stability of a D-ring that is placed in a cradle (open holding portion, curved holding portion, etc.) 1320 (FIGS. 15A-B) along with webbing (e.g., webbing 1610 and 1620, FIG. 15) that is placed over an opening portion of a D-ring (or other ring device). In one embodiment, the cradle 1320 includes a raised or hump portion 1510. In one embodiment, the though-hole, slot or channel provides for placement of an SRD connector (e.g., round carabiners, oval carabiners, etc., either made of aluminum, steel, etc.) and around the connected webbings 1610 and 1620 (FIG. 16).

In one embodiment, the device 1300 includes a first webbing entry opening (or slot) 1315 and a second webbing entry opening (or slot) 1316 that provide for harness webbing to enter the device 1300. In some embodiments, the device 1300 includes webbing transition openings (or slots) 1320, 1321, 1322 and 1323 that each include angled portions of a slot that form a V-shaped opening (or slot) for further attaching harness webbing. The webbing transition openings 1320, 1321, 1322 and 1323 each include a point (or portion) near or at the middle at a formed “V” portion (upper and lower V-shaped portions) that provides for maintaining the webbing of a harness aligned withing the webbing transition openings 1320, 1321, 1322 and 1323 such that the webbing does not bunch up or move to one side of the webbing transition openings 1320, 1321, 1322 and 1323 during use.

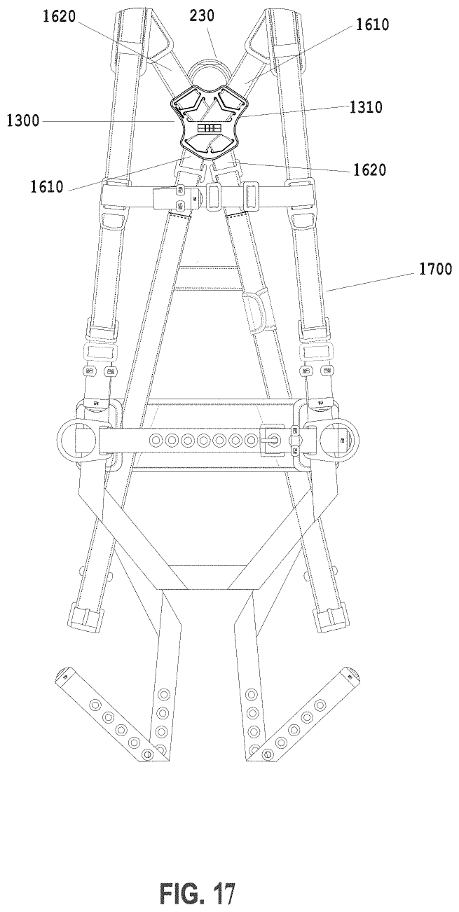

In some embodiments, the device 1300 further includes a first D-ring (or ring) attachment opening (or slot) 1330 and a second D-ring (or ring) attachment opening (or slot) 1335. The first D-ring attachment opening (or slot) 1330 provides for the webbing 1610 (FIG. 16) to enter from the rear side of the device 1300 through the rear side of the transition opening 1321 for maintaining a D-ring in place on the cradle 1320 (FIGS. 15A-B) of the D-ring position keeper 1340. The first D-ring attachment opening (or slot) 1330 further provides for the webbing 1620 (FIG. 16) to enter from the rear side (see, e.g., FIG. 13B) of the device 1300 through the rear side of the transition opening 1323 for maintaining a D-ring in place on the cradle 1320 (FIGS. 15A-B) of the D-ring position keeper 1340. From the rear side of the device 1300, the webbings 1610 and 1620 enter through the rear side of the first D-ring attachment opening (or slot) 1330 and are placed together (one over the other) over the bottom connection opening 1630 (FIG. 16) of the D-ring 230. The webbing 1610 is placed through the front side of a second D-ring attachment opening (or slot) 1335 and out through the rear side, and enters a rear side of a first webbing exit opening (or slot) 1326 and leaves from the front side of the first webbing exit opening (or slot) 1326, and continues to the rest of the harness as shown in the FIG. 17. Similarly, the webbing 1620 is placed through the front side of the second D-ring attachment opening (or slot) 1335 and out through the rear side, and enters a rear side of a second webbing exit opening (or slot) 1325 and leaves from the front side of the second webbing exit opening (or slot) 1325, and continues to the rest of the harness as shown in the FIG. 17. The first webbing exit opening (or slot) 1326 and the second webbing exit (or slot) 1325 each include a point (or portion) near or at the formed V-shaped portion (upper and lower V-shaped portions) that provides for maintaining the webbing of a harness aligned withing the first webbing exit opening (or slot) 1326 and the second webbing exit (or slot) 1325 such that the webbing does not slip, bunch up or move to one side of the first webbing exit opening (or slot) 1326 or the second webbing exit opening (or slot) 1325 during use.

In one embodiment, the webbing transition openings 1320, 1321, 1322 and 1323 each include smooth openings without any sharp edges (e.g., rounded edges, etc.), even at the point (or portion) near or at the formed V portion. The webbing transition openings 1320, 1321, 1322 and 1323 have an equal length on either side of the point or portion (upper and lower points/portions of the opening) near or at the formed V-shaped portions. In one embodiment, the width of the openings for the webbing transition openings 1320, 1321, 1322 and 1323, and the first webbing entry opening (or slot) 1315 and the second webbing entry opening (or slot) 1316 are 3 mm. In other embodiments, the width of the openings for the webbing transition openings 1320, 1321, 1322 and 1323, and the first webbing entry opening (or slot) 1315 and the second webbing entry opening (or slot) 1316 have a range of 2 mm-4 mm.

In one embodiment, the first D-ring attachment opening (or slot) 1330 and the second D-ring attachment opening (or slot) 1335 each include smooth openings without any sharp edges (e.g., rounded edges, etc.). In one embodiment, the openings of the first D-ring attachment opening (or slot) 1330 and the second D-ring attachment opening (or slot) 1335 have a width of 6.5 mm. In other embodiments, the openings of the first D-ring attachment opening (or slot) 1330 and the second D-ring attachment opening (or slot) 1335 have a width with a range of 4 mm-8 mm.

In one embodiment, the first webbing exit opening (or slot) 1326 and the second webbing exit opening (or slot) 1325 each include smooth openings without any sharp edges (e.g., rounded edges, etc.), even at the point (or portion) near or at the formed V portion. The first webbing exit opening (or slot) 1326 and the second webbing exit opening (or slot) 1325 have an unequal length on either side of the point (upper and lower points (1351/1352 FIG. 13B) of the opening) near or at the formed V portion. In one embodiment, the length 1353 (or distance) between the lower formed V points 1351/1352 formed of each of the first webbing exit opening (or slot) 1326 and the second webbing exit opening (or slot) 1325 is 45 mm, which is the same as the length of the second D-ring attachment opening (or slot) 1335. The first webbing exit opening (or slot) 1326 and the second webbing exit opening (or slot) 1325 provide a functional means to incorporate the torso webbing from a safety harness through the base plate 1310 or the D-ring keeper 1340 with an SRD adaptor assembly. Without this feature the critical dorsal D-ring placement would be lost and the safety of the user would be jeopardized.

In one embodiment, the materials for the base plate 1310 may include high-density polyethylene (HDPE or HDPE plastic), thermoplastic elastomer (TPE), or a combination of the two. In other embodiments, the materials for the base plate 1310 may include steel, a steel alloy, an aluminum alloy, plastic resins, leather, fabric, etc. In one embodiment, the materials for the base plate 1310 are 70% HDPE and 30% TPE. In other embodiments, the percentages of HDPE and TPE may range from 60-80% HDPE and 40-20% TPE.

FIG. 13B shows a rear view of the device 1300 of FIG. 13A including the integrated SRD connection point and D-ring position keeper 1340, according to one embodiment. In one embodiment, the D-ring keeper 1340 is a feature that allows a (dorsal) D-ring 230 to maintain a safe and fixed distance from the SRD connection point. If the D-ring keeper 1340 and the SRD connection point are not within reasonable proximity of each other, the device 1300 function can be jeopardized by becoming “lost” once the safety harness webbings 1610/1620 (FIG. 16) have been laced through the base plate 1310 via the first webbing entry opening (or slot) 1315, the second webbing entry opening (or slot) 1316, the webbing transition openings 1320, 1321, 1322 and 1323, the first webbing exit opening (or slot) 1326 and the second webbing exit opening (or slot) 1325. The D-ring keeper 1340 may also be strategically contoured or shaped to suit the intended D-ring 230 creating a stand-up or upright D-ring position, which makes it easier for the user to connect/disconnected lanyards and SRDs that are provided to be connected directly to a dorsal D-ring.

In one embodiment, the D-ring 230 is held in place in a specific location. SRDs have a specific allowable usage marked on every unit. For example, an SRD can be used only for overhead, 2′ below D-ring, 3′ below D-ring, 4′ below D-ring or foot level tie-off, etc. These are very specific instructions on personal SRDs. Therefore, if the SRD connection point is too far away from the D-ring 230 one can end up with a miscalculation on the clear fall distance, which is the amount of distance one needs to calculate for a fall to prevent the user from hitting the lower level (or ground).

In some embodiments, the outer shape of the device 1300 incorporating a D-ring keeper 1340 and SRD connection point along with the inner shape are strategically designed to serve specific purposes. In one example embodiment, the outer shape is designed to accommodate common SRD connection options, such as oval carabiners, conventional shaped aluminum carabiners, steel carabiners, etc. that are common to the fall protection market. Without the shape designed in the above-discussed embodiments, the devices would be limited regarding the SRD connection options.

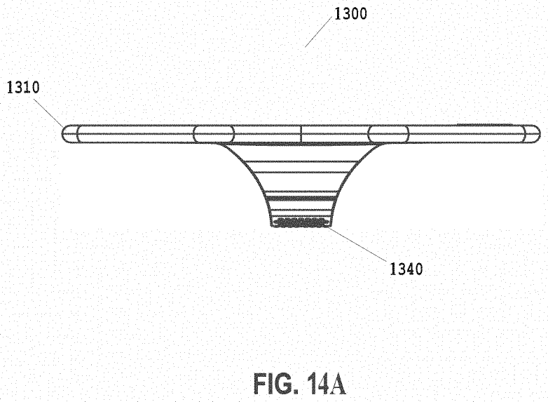

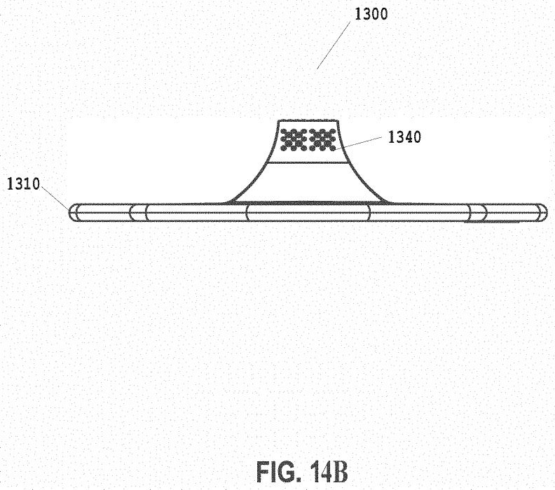

FIG. 14A shows a top view of the device 1300 of FIG. 13A including the integrated SRD connection point and D-ring position keeper 1340, according to one embodiment. FIG. 14B shows a bottom view of the device 1300 of FIG. 13A including the integrated SRD connection point and D-ring position keeper 1340, according to one embodiment. In one embodiment, the base plate 1310 of the device 1300 is substantially flat on the rear side, which would be facing the back of a user. FIG. 15A shows a right side view of the device 1300 of FIG. 13A including the integrated SRD connection point and D-ring position keeper 1340, according to one embodiment. FIG. 15B shows a left side view of the device 1300 of FIG. 13A including the integrated SRD connection point and D-ring position keeper 1340, according to one embodiment.

FIG. 16 shows a front view of the device 1300 of FIG. 13A including the integrated SRD connection point and D-ring position keeper 1340 that is shown with example webbing 1610/1620 from a fall protection harness 1700 (FIG. 17), according to one embodiment. In some embodiments, the angle of the formed “V” of the webbing transition openings 1320, 1321, 1322 and 1323, the first webbing exit opening (or slot) 1326 and the second webbing exit opening (or slot) 1325 provide the proper alignment for the webbings 1610 and 1620 as they enter, exit and transition through the device 1300.

FIG. 17 shows a front view of the device 1300 of FIG. 13A including the integrated SRD connection point and D-ring position keeper 1340 that is shown with an example fall protection harness 1700, according to one embodiment. In some embodiments, the device 1300 may be included with a harness 1700, or may be added to a harness 1700 as required for fall protection that requires an SRD attachment and dorsal placed D-ring 230. The webbings 1610 and 1620 can be seen as “bending” through the device 1300 for proper alignment and exit angle of the webbings 1610 and 1620 from the device 1300. This provides for added comfort for the user, added safety features from a connection point for properly placing/positioning an SRD and for maintaining a D-ring 230 at a proper required location, position and angle for connection with a carabiner or other device.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus comprising:
a base plate comprising a plurality of entry webbing slots, a plurality of exit webbing slots and a plurality of webbing transition slots;
a ring connection element coupled to the base plate, the ring connection element comprising an opening configured for removably coupling with a ring device; and
a self-retracting device (SRD) connection integrated with the ring connection element.

2. The apparatus of claim 1, wherein the plurality of exit webbing slots each comprise a V-shaped opening.

3. The apparatus of claim 2, wherein the V-shaped opening of each of the plurality of exit webbing slots comprises an upper V-shaped portion and a lower V-shaped portion.

4. The apparatus of claim 3, wherein the V-shaped opening of each of the plurality of exit webbing slots have unequal length portions on opposite sides of the upper V-shaped portion and the lower V-shaped portion.

5. The apparatus of claim 2, wherein the plurality of webbing transition slots each comprise a V-shaped opening.

6. The apparatus of claim 5, wherein the V-shaped opening of each of the plurality of webbing transition slots comprises an upper V-shaped portion and a lower V-shaped portion.

7. The apparatus of claim 6, wherein the V-shaped opening of each of the plurality of webbing transition slots have equal length portions on opposite sides of the upper V-shaped portion and the lower V-shaped portion.

8. The apparatus of claim 3, further comprising a first ring attachment slot and a second ring attachment slot.

9. The apparatus of claim 8, wherein a length between the lower V-shaped portion of each of the plurality of exit webbing slots is equal to a length of the second ring attachment slot.

10. The apparatus of claim 2, wherein the ring connection element comprises a cradle with a hump portion.

11. An apparatus including an integrated self-retracting device (SRD) connection and D-ring connection element, the apparatus comprising:
a base plate comprising a first entry webbing slot, a second entry webbing slot, a first exit webbing slot, a second exit webbing slot and a plurality of webbing transition slots;
a D-ring connection element integrated with the base plate; and
an SRD connection integrated with the D-ring connection element,
wherein the SRD connection comprises a through-hole within the D-ring connection element.

12. The apparatus of claim 11, wherein the plurality of exit webbing slots each comprise a V-shaped opening.

13. The apparatus of claim 12, wherein the V-shaped opening of each of the plurality of exit webbing slots comprises an upper V-shaped portion and a lower V-shaped portion.

14. The apparatus of claim 13, wherein the V-shaped opening of each of the plurality of exit webbing slots have unequal length portions on opposite sides of the upper V-shaped portion and the lower V-shaped portion.

15. The apparatus of claim 11, wherein the plurality of webbing transition slots each comprise a V-shaped opening, the V-shaped opening of each of the plurality of webbing transition slots have equal length portions on opposite sides of the upper V-shaped portion and the lower V-shaped portion.

16. The apparatus of claim 15, further comprising a first ring attachment slot and a second ring attachment slot.

17. The apparatus of claim 16, wherein a length between the lower V-shaped portion of each of the plurality of exit webbing slots is equal to a length of the second ring attachment slot.

18. The apparatus of claim 12, wherein the ring connection element comprises a cradle with a hump portion.

19. An apparatus including an integrated self-retracting device (SRD) connection and D-ring connection element, the apparatus comprising:
a base plate comprising a first entry webbing slot, a second entry webbing slot, a first exit webbing slot, a second exit webbing slot, a plurality of webbing transition slots, a first ring attachment slot and a second ring attachment slot;
a D-ring connection element integrated with the base plate; and
an SRD connection integrated with the D-ring connection element,
wherein the SRD connection comprises a through-hole within the D-ring connection element.

20. The apparatus of claim 19, wherein:
the plurality of exit webbing slots each comprise a V-shaped opening;
V-shaped opening of each of the plurality of exit webbing slots comprises an upper V-shaped portion and a lower V-shaped portion;
the V-shaped opening of each of the plurality of exit webbing slots have unequal length portions on opposite sides of the upper V-shaped portion and the lower V-shaped portion;
the plurality of webbing transition slots each comprise a V-shaped opening;
the V-shaped opening of each of the plurality of webbing transition slots have equal length portions on opposite sides of the upper V-shaped portion and the lower V-shaped portion;
a length between the lower V-shaped portion of each of the plurality of exit webbing slots is equal to a length of the second ring attachment slot; and
the ring connection element comprises a cradle with a hump portion.
